(19) United States
(12) Patent Application Publication
(10) Pub. No.: US 2003/0234495 A1
(43) Pub. Date: Dec. 25, 2003

(54) Flow induced mechanical seal

(76) Inventor: Alan James Roddis, Sheffield (GB)

Correspondence Address: MYERS BIGEL SIBLEY & SAJOVEC, PO BOX 37428, RALEIGH, NC, 27627, US

(21) Appl. No.: 10/391,508

(22) Filed: Mar. 18, 2003

(30) Foreign Application Priority Data
Mar. 18, 2002 (GB) GB 0206263.6

(51) Int. Cl. F16J 15/34

(52) U.S. Cl. 277/367

(57) ABSTRACT

A fluid flow inducer comprises a stationary part and a rotating part, and has a first member having a radially indented face, and a second member having a radially and outwardly inclined surface. The outwardly inclined surface is spaced from and faces the radially indented face. One of the radially indented face and the outwardly inclined surface is configured for provision on the stationary part, and the other of the radially indented face and the outwardly inclined surface is configured for provision on the rotating part.

### RELATED APPLICATION

This application claims priority to Great Britain Patent Application No. GB 0206263.6, filed Mar. 18, 2002, the disclosure of which is hereby incorporated herein by reference.

1. Field of the Invention

This invention relates to fluid circulation devices and especially mechanical seals with flow induced barrier/buffer fluids.

2. Background of the Invention

A mechanical seal comprises a “floating” component which is mounted axially movably around the rotary shaft of, for example a pump and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more springs. In use, one of the floating and static components rotates. This component is therefore referred to as the rotary component. The other of the floating and static components does not rotate and is referred to as the stationary component.

Those seals whose floating component is rotary are described as rotary seals. If the floating component is stationary, the seal is referred to as a stationary seal.

If the sliding seal between the rotary and stationary components are assembled and pre-set prior to despatch from the mechanical seal manufacturing premises, the industry terminology for this is “cartridge seal”. If the rotary and stationary components are despatched individually (unassembled) from the mechanical seal manufacturing premises, the industry terminology for this is “component seal”.

Flow induced barrier fluid systems are frequently employed in mechanical seal design, as they facilitate the removal of heat within the barrier fluid system, therefore helping to pro-long the seal survival. Reference is made to our co-pending patent application, U.S. Ser. No. 09/398,529.

Flow induced seals which ensure barrier/buffer fluid flow circulation independent of the direction of shaft/seal rotation, are thought to be advantageous, particularly if the flow rates/flow characteristics are similar/identical in both directions of shaft rotation.

The bi-directional ability of the flow inducer is further complimented if the barrier/buffer flow characteristics are independent of the piping arrangement (in/out) employed.

A prior art design (Nagai et al U.S. Pat. No. 4,545,588) which could be suggested to be unidirectional, and circulate fluid in one direction only, is illustrated, in FIG. 1.

### BRIEF DESCRIPTION OF THE DRAWINGS

The present invention is described by way of example only with reference to the accompanying drawings, in which:

FIG. 2 is a longitudinal cross section through a double bellows mechanical seal of the invention.

FIG. 3 corresponds to FIG. 2 and is a partial longitudinal cross section through a double rotary mechanical seal of the invention, illustrating the flow inducer device.

FIG. 4 corresponds to FIG. 3 and is an end view of the flow inducing device.

FIG. 5 corresponds to FIG. 3 and shows an alternative flow indentation with a curved indentation base.

FIG. 6 corresponds to FIG. 3 and shows an alternative flow deflector with an inner curved region adjacent to at least one tapered region.

FIG. 7 corresponds to FIG. 4 and shows an alternative flow indentation form.

### DETAILED DESCRIPTION OF PREFERRED EMBODIMENTS

It is considered self evident to the experienced reader that the invention may be employed for both rotary seals and stationary seals, and/or, for single mechanical seals and triple mechanical seals as well as double mechanical seals, whether designed in a cartridge or component seal format.

It is also considered self evident that the invention may be used with metallic components as well as non-metallic components.

FIG. 1 is an extract from Nagai et al (U.S. Pat. No. 4,545,588) which defines a mechanical seal design with a helical groove (12) in the rotating member. The helical grooves are located on the outer most radial circumference of the rotating member. Nagai later defines said grooves as circumferencial grooves. Opposite to the helical grooves, Nagai also defines a stationary member with a taper surface.

A person skilled in the art will appreciate that Nagai (U.S. Pat. No. 4,545,588) does not accommodate a means for promoting the axial flow of a fluid irrespective of shaft rotation. This drastically limits where the design can be applied and creates a commercial penalty for the user due to increased seal inventory levels, to cater for equipment, which rotates in differing directions.

Furthermore, as the helical grooves of Nagai are on the circumferencial portion of the rotating member, radial shaft movement, as commonly found in a piece of rotating equipment, can drastically impair the operational performance of the flow induction design. This is a further limiting factor of Nagai.

A skilled person will further appreciate that there are a number of inventions, which relate to gas lift mechanical seals. By way of example only Kulkarni (U.S. Pat. No. 5,498,007) defines such a gas lift design.

Kulkarni defines a series of grooves in the sealing face of a mechanical seal. Said grooves are inclined, with respect to each other in the plan view. According to Kulkarni, said grooves pump the gas irrespective of shaft rotation.

A limiting factor with Kulkarni is that the grooves are located in the sealing face of the mechanical seal. A person skilled in the art will appreciate that sealing face is perpendicular to the rotating shaft.

The seal face is the primary element that prevents the sealed media from escaping. Accordingly, seal faces are required to be perfectly flat. The rotating seal face runs parallel to the stationary seal face. The seal faces are axially mounted, and typically one seal face is spring loaded against the other. An axial gap between a set of seal faces is not permitted, as the sealed fluid would escape. Gas seal faces are reported to separate when the rotating shaft speed is sufficient so to generate hydrodynamic gas lift or pressure differential between the seal faces. The amount of axial separation between the two faces is very small and in the order of 0.0001″ (0.002 mm). If one of the two gas lift faces is not spring loaded, any axial equipment movement, between the shaft and the stationary housing, or even axial vibration, would cause the seal faces to be damaged.

An experienced person will note that for any gas lift seal face design to function at all, one of the seal faces must be axially moveable to the second, typically by the use of one or more spring members. Both faces must be perpendicular to the axis of the rotating shaft and the gap between the two seal faces must be practically zero.

An invention which can be used in conjunction, or independent of, a mechanical seal, which pumps a fluid irrespective of shaft rotation and with a large axial gap between the rotating and stationary elements is deemed to be particularly advantageous. The invention is deemed further advantageous if the rotating element is not required to be axially moveable relative to the stationary element.

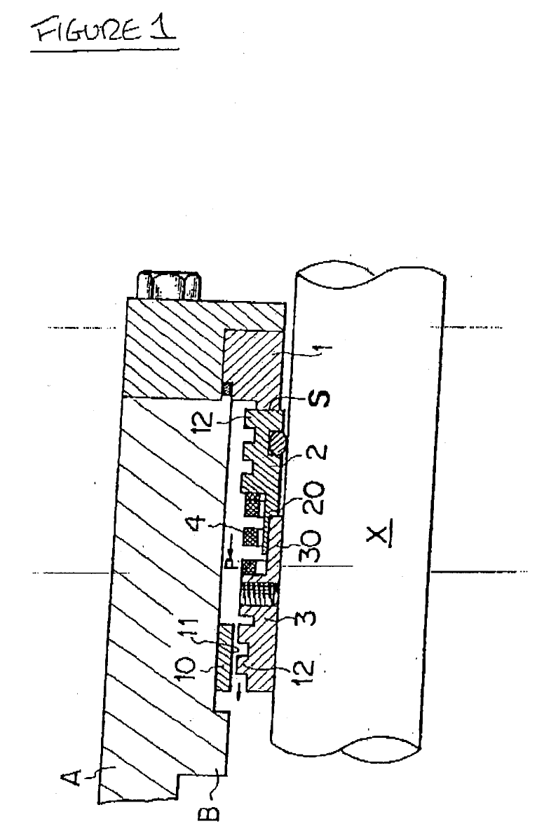

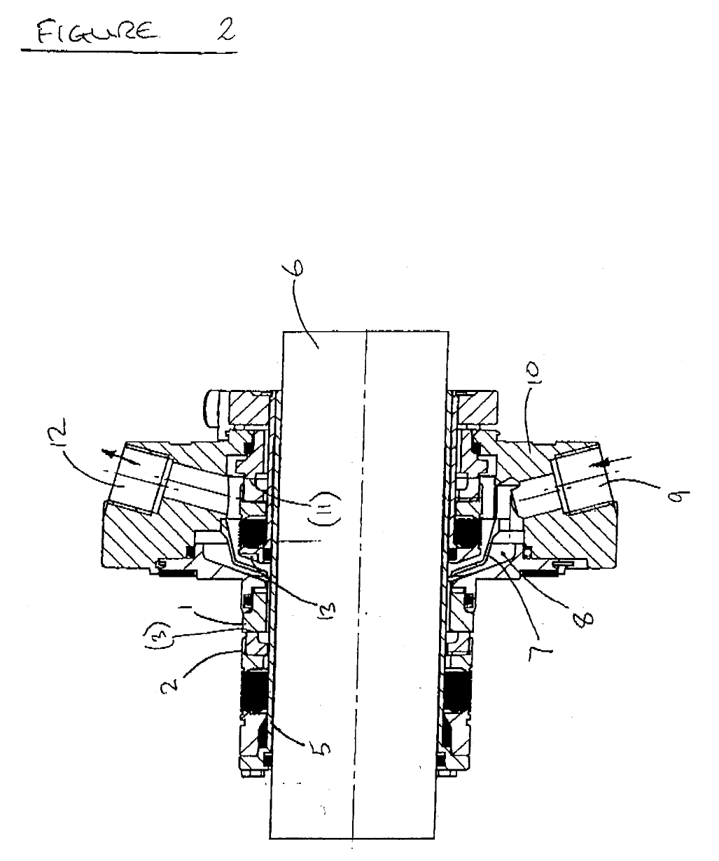

FIG. 2 therefore shows a double rotary bellows mechanical seal according to the invention. The seal is a cartridge seal and comprises of a stationary component (1) and a rotary component (2) which defines a seal surface (3) which in turn forms a sliding seal with the stationary component (1).

The rotary component (2) is disposed radially outwardly of rotary member (5), which is a sleeve fixed for rotation with a rotary shaft (6) of an item of mechanical equipment. The deflector (7), is positioned radially outwardly around the sleeve component (5), and in this illustration, is stationary.

FIG. 2, illustrates the barrier fluid (8) entering in the barrier fluid inlet (9) in gland (10), and circulated along the outer radial portion of the deflector (7), and directed towards the inboard sealing surface (3). The barrier fluid (8) is then pulled along the inner radial portion of deflector (7), by means of the invention, and past the outboard sealing surface (11) and towards the barrier fluid outlet (12) in gland (10). The barrier fluid is then circulated within a closed circuit, preferably, back to the source, then back to the barrier fluid inlet (9).

The flow inducer (13) is positioned between the inboard sealing surface (3) and outboard sealing surface (11).

The radially outer surface of the flow inducer (13) is preferentially positioned with a relatively large radial gap to the inner radial surface of the deflector (7).

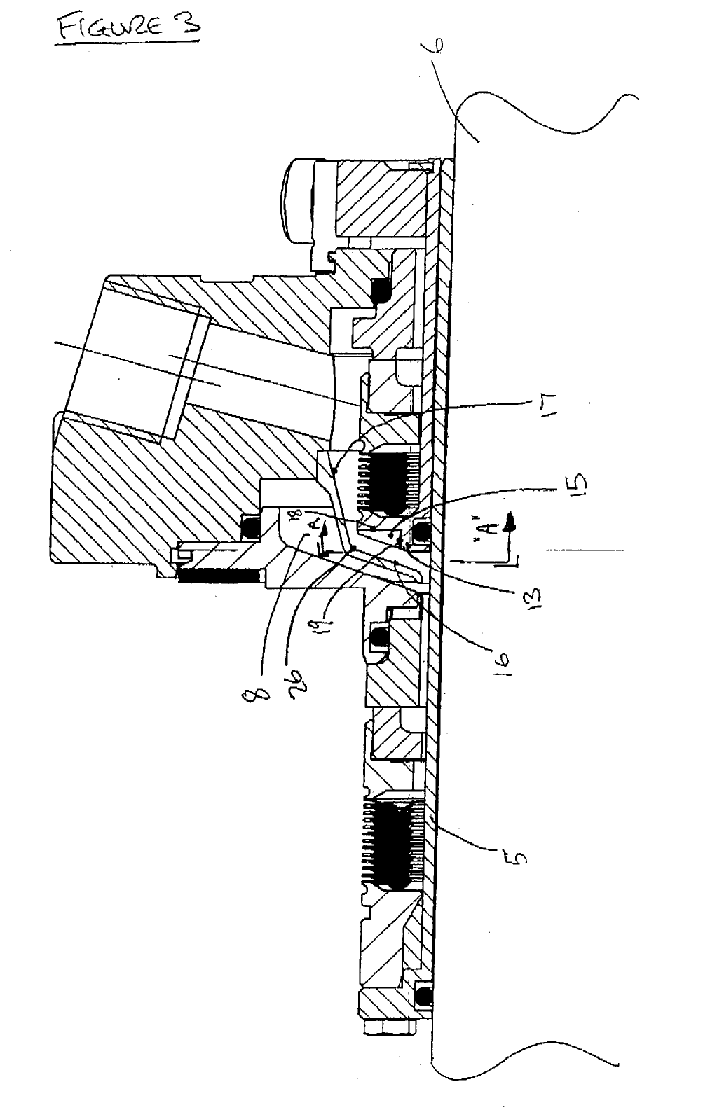

FIG. 3 corresponds to FIG. 2 and is a partial cross section of the invention. From FIG. 3, the flow inducer (13) incorporates at least one axial indentation (15).

Said indentation (15) rotates with the sleeve (5) and pumps the barrier fluid (8) radially outwardly until said barrier fluid (8) contacts the underside of the deflector (7). The inner most radial surface of the deflector (7) is double tapered. The primary tapered surface (16) is preferentially angled between 89 degrees and 45 degrees from the shaft (6) axis. The secondary tapered surface (17) is preferentially angled between 44 degrees and 1 degree from the shaft (6) axis

The deflector (7) preferentially contains a double tapered inner most surface. The first taper (16) is angled closer to 89 degrees than the second taper (17) which is in turn angled closer to the rotating shaft (6) axis at 0 degrees when viewed in the horizontal plane.

At least one indentation (15) is positioned to produce fluid flow from a clockwise rotational movement. The same indentation also produces fluid flow from an anti-clockwise rotational movement. Fluid flow is therefore achieved irrespective of shaft rotational direction.

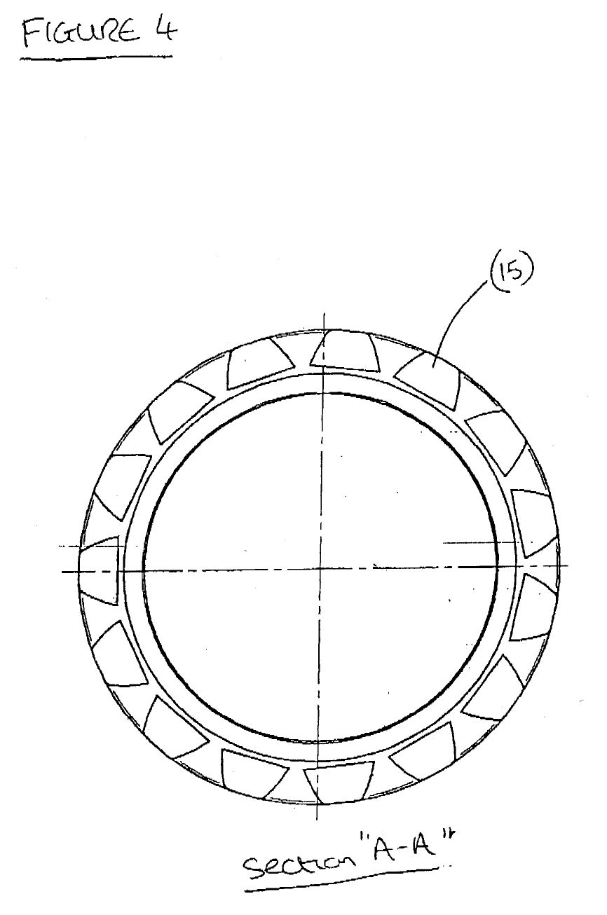

FIG. 4 shows a view on the end of the rotating member illustrating, by way of example only, the angular positioning of more than one indentation (15).

It will be noted from FIG. 3, that the indentation (15) includes a first indentation base (18) which is relatively perpendicular to the axis of rotating shaft (6), and a second indentation base (19) which is relatively parallel to the axis of the rotating shaft (6).

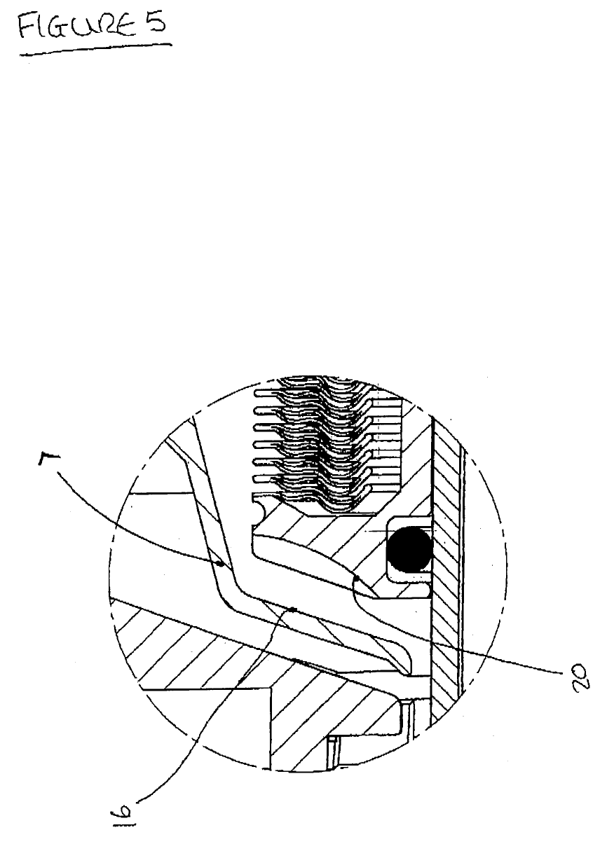

By way of example only, FIG. 5 shows an alternative indentation base (10) form, which is concave curved adjacent to the steeper portion (16) of the tapered defector (7).

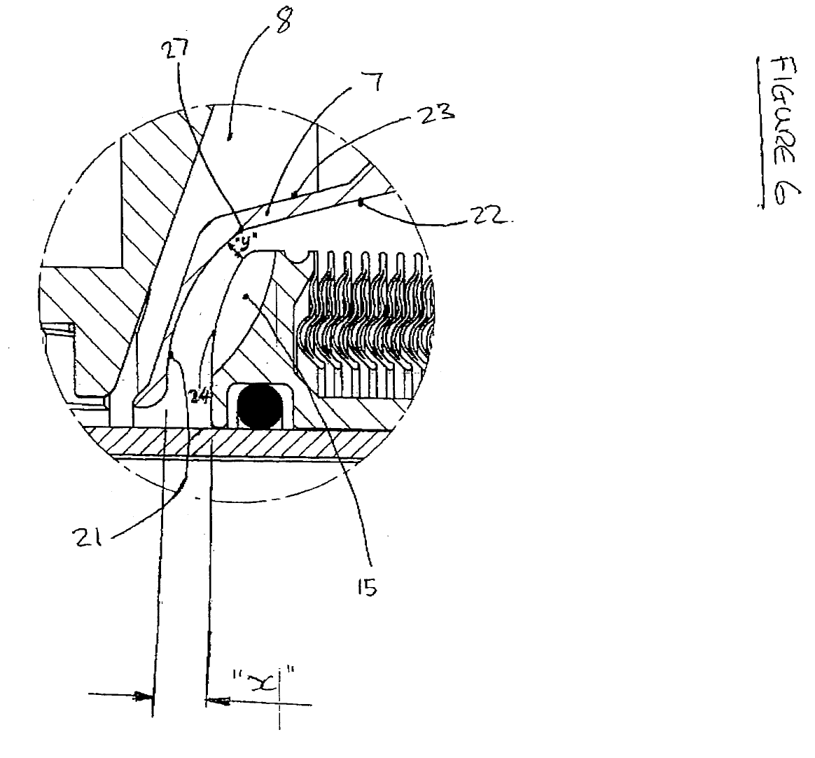

Again, by way of example only, FIG. 6 shows an alternative deflector (7) profile, which has a concave curved portion (21) opposite to the the rotating indentation (15). Said concave curved portion (21) on the deflector (7) is tangential to at least one angled portion of the deflector (7).

It will be noted from FIG. 6, that unlike Nagai et al (U.S. Pat. No. 4,545,588), the pumped fluid (8) is allowed to travel around the outer most radial part (23) of the deflector (7) as well as the inner most radial part (21 and 22). The outer most radial part (23) of the deflector (7) has a tapered surface, relatively parallel to the inner most tapered part (22).

Said taper on the outer most radial part (23) allows the fluid to be directed effectively, with minimal fluid turbulence, to the inboard mechanical seal surface (3). This is deemed considerably advantageous as, in itself, the invention can be applied to axially restrictive applications with maximum fluid (8) exchange at the seal surfaces (3) and (11).

It will be further noted from FIG. 6 that the outer most axial portion of the indentation (15) is convex curved (24). This is a further option of the invention, preferentially when the axial distance, denoted as “x”, in FIG. 6, is larger than the axial distance “y”, which is radially outwardly positioned with respect to “x”.

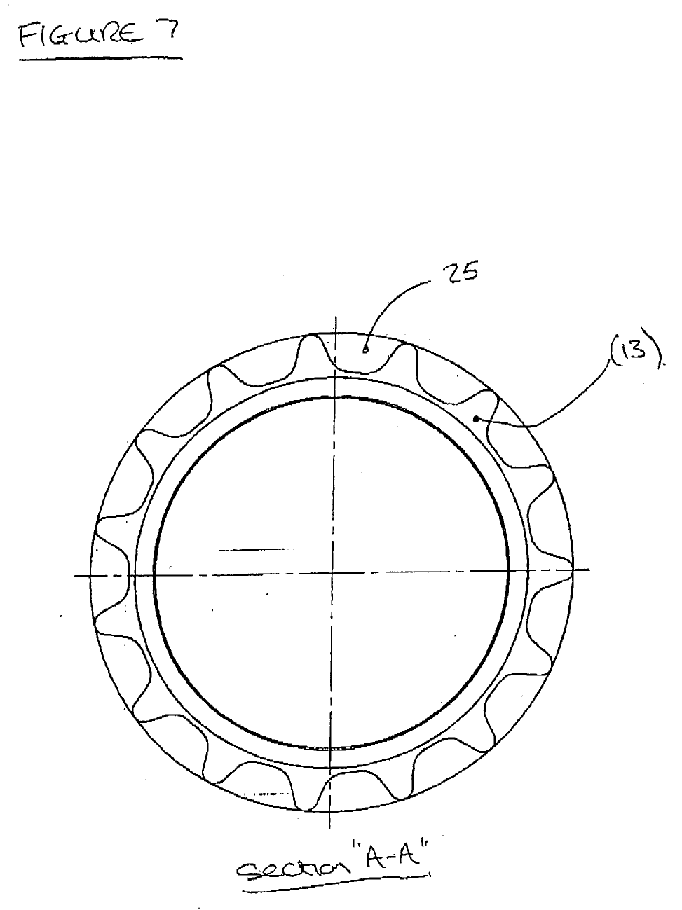

Again, by way of example only, FIG. 7 shows an alternative indentation form (25), in the end view of the rotating member (13).

Unlike our co-pending application U.S. Pat. No. 09/398,529, the invention utilises a single indentation, positioned on an axial part of the rotating member, to effectively circulate fluid irrespective of shaft rotation.

Furthermore the deflector (7), of the invention, incorporates more than one internal tapered area (16) and (17). It has been surprisingly found that this double internal tapered design of the invention acts to improve the flow, velocity and direction of the fluid (8).

As the fluid (8) circulates more efficiently around the mechanical seal barrier chamber, less heat is introduced into the fluid (8); therefore the mechanical seal runs cooler. This is a considerable advantage over the prior art technology, as this can extend seal and equipment life before maintenance/breakdown.

It has been further found that the fluid (8) velocity is improved if the intersection between the two inner tapers (16) and (17) of deflector (7) is blended by a large radius (26) in FIG. 3.

This feature of the invention is further shown in FIG. 6, where the concave curve (21) is tangentially blended at-the intersection (27) with the inner tapered portion (22).

An experienced reader will understand that in order for U.S. Pat. No. 09/398,529 to pump fluid irrespective of shaft rotation, U.S. Pat. No. 09/398,529 utilises at least two counter angled vanes, positioned on the circumferential portion of the rotating member. The pumping vanes incorporate a tapered vane base which is relatively parallel to the opposing stationary tapered region. The deflector in U.S. Ser. No. 09/398,529 also includes one tapered region and one adjacent portion which is perpendicular to the shaft.

It is considered self evident that the deflector and flow induction design of the invention, could be positioned between two sets of mechanical seal faces, as shown in FIG. 3, or in any axial position with respect to a set of seal faces, given the need to do so.

The invention is not limited to the embodiments hereinbefore described with reference to the accompanying drawings, which may be varied in construction and detail.

That which is claimed is:

1. A fluid flow inducer comprising a stationary part and a rotating part, and having a first member having a radially indented face, and a second member having a radially and outwardly inclined surface spaced from and facing the radially indented face, one of the radially indented face and the outwardly inclined surface being configured for provision on the stationary part, and the other of the radially indented face and the outwardly inclined surface being configured for provision on the rotating part.

2. A fluid flow inducer according to claim 1 wherein said outwardly inclined surface comprises two tapers adjacent to one another, the first taper is angled closer to 89 degrees from the horizontal axis of the rotating equipment than the second taper, and the second taper is angled closer to 1 degrees from said horizontal axis of the rotating equipment than the first taper.

3. A fluid flow inducer according to claim 1 wherein said outwardly inclined surface comprises two tapers adjacent to one another, the first taper is angled between 89 degrees and 45 degrees from the horizontal axis of the rotating equipment, the second taper is angled between 44 degrees and 1 degrees from said horizontal axis of the rotating equipment, viewed from the side elevation.

4. A fluid flow inducer according to claim 1 wherein said outwardly inclined surface comprises at least one concave region, the inner radial surface of said concave region tangentially starts and/or finishes between 1 degrees and 89 degrees from the horizontal axis of the rotating equipment, viewed from the side elevation.

5. A fluid flow inducer according to claim 1 wherein said outwardly inclined surface comprises at least one concave region and at least one adjacent tapered region, the inner radial surface of said concave region is tangentially adjacent to said tapered region.

6. A fluid flow inducer according to claim 1 further comprising at least one of two tapered regions, two concave regions, and a concave region adjacent to a tapered region, said regions being blended with a radius that is radially disposed to the rotating indentation.

7. A fluid flow inducer according to claim 1 wherein said radially indented face comprises at least two indentation bases, the first of which is relatively perpendicular to the rotating equipment axis, the second of which is relatively parallel to the rotating equipment axis.

8. A fluid flow inducer according to claim 1 wherein said radially indented face comprises at least one concave indentation base.

9. A fluid flow inducer according to claim 1 wherein said radially indented face comprises at least one concave indentation base, said concave indentation base tangentially starts and/or finishes between 1 degrees and 89 degrees from the horizontal axis of the rotating equipment, viewed in the side plane.

10. A fluid flow inducer according to claim 1 which comprises at least one set of seal faces and at least one radially indented face axially and radially adjacent to a stationary member, wherein said radially indented face circulates fluid irrespective of rotational equipment direction.

11. A fluid flow inducer according to claim 1 which comprises at least two sets of seal faces and at least one radially indented face axially displaced between each of the seal face sets, said radially indented face is axially and radially adjacent to a stationary member, where said radially indented face circulates fluid between the two sets of seal faces, irrespective of rotational equipment direction.

12. A fluid flow inducer according to claim 1 wherein the outer profile of the radially indented face is convex profiled.

13. A fluid flow inducer according to claim 1 wherein the outer profile of the radially indented face is convex profiled, said convex profile, is adjacent to a concave profile in an axially and radially disposed stationary member.

14. A fluid flow inducer according to claim 1 wherein the outer profile of the radially indented face is convex profiled, said convex profile is adjacent to a concave profile in an axially and radially disposed stationary member, said axial distance between said rotating and stationary members decreases radial outwardly of the horizontal axis of the piece of rotating equipment, when viewed from the side elevation.

15. A device comprising a flow inducer to induce fluid movement, the flow inducer comprising a first member and a second member, the first member being rotatable relative to the second member, the first member comprising at least one indentation, and the second member comprising at least one radially outwardly inclined region.

16. A device according to claim 15 wherein the indentation is axially adjacent to and radially disposed of the radially outwardly inclined region.

17. A device according to claim 15 wherein the device comprises a mechanical seal.
